(19) United States
(12) Patent Application Publication
(10) Pub. No.: US 2004/0132523 A1
(43) Pub. Date: Jul. 8, 2004

(54) Game payout value modification system and methods

(75) Inventor: Michael Staw, Atlanta, GA (US)

Correspondence Address: GREENBERG-TRAURIG, 1750 TYSONS BOULEVARD, 12TH FLOOR, MCLEAN, VA, 22102, US

(73) Assignee: RealTime Gaming, Inc., Atlanta, GA (US)

(21) Appl. No.: 10/670,777

(22) Filed: Sep. 26, 2003

Related U.S. Application Data
(60) Provisional application No. 60/413,470, filed on Sep. 26, 2002.

(51) Int. Cl. A63F 13/00

(52) U.S. Cl. 463/16

(57) ABSTRACT

A game enhancement that selects randomly, or pseudo-randomly, from a set of possible winning combinations and designates the selected winning combination as a bonus pay or alternative winning combination. The game is then played according to traditional rules. In one embodiment, if the player's result matches the bonus pay combination the player is paid or otherwise rewarded at a higher rate than is typical for the player's result. In an alternative embodiment, if the player's result matches an alternative winning combination, the player is paid regardless of whether he or she has won the game.

The present invention is related to, and claims priority from, Provisional U.S. Patent Application Serial No. 60/413,470, which is incorporated herein by reference in its entirety, including all drawings and appendices.

### FIELD OF THE INVENTION

The present invention relates to the field of gaming, and more particularly provides an enhancement to card games.

### BACKGROUND OF THE INVENTION

Various forms of playing cards have existed since approximately 900 A.D., and many games have been invented using playing cards. Poker is one of the most popular card games in America today. Poker's origins are unclear, but some of the first direct references to the game have been found in New Orleans and date back to approximately 1830. The game was immediately popular, and by the late 1830's, game play had spread up and down the Mississippi and Ohio rivers, and even to the east coast. One reason for Poker's popularity is that, unlike most wagering games, Poker is played against other players, rather than against the game operator, or “house”. Instead, the house may charge a fee to sit at a Poker table, and can collect a percentage of a player's winnings (called that “rake”).

There are many variations on the basic Poker game, including five-card stud, five-card draw, seven-card stud, seven-card draw, Texas Hold'em, Omaha Hold'em, Iron Cross, Follow the Queen, and the like. Each of these variations modifies the game play in a specific manner, but all variations still use the same card and hand rankings, and most still have as their objective obtaining a hand of the highest rank. The number cards are ranked according to the value of the number on the card, with 2's being the lowest rank and 10's the highest rank. Face cards are ranked with Kings the highest, Queens second, and Jacks third. All face cards outrank number cards. Aces outrank face cards.

Hands are ranked according to the following chart, with the Royal Flush as the highest rank hand, and the High Card as the lowest rank:

TABLE 1

| Hand Name | Description |
|---|---|
| Royal Flush | A, K, Q, J, 10 all of the same suit |
| Straight Flush | All cards in the hand are of the same suit, in sequence |
| Four of a kind | Four cards of the same rank |
| Full House | A Three of a Kind and a Pair in the same hand |
| Flush | All cards in the hand are of the same suit |
| Straight | All cards in the hand in sequence |
| Three of a Kind | Three cards of the same rank |
| Two Pair | Two cards of one rank, plus two cards of another |
| Pair | Two cards of the same rank |
| High Card | Highest rank card |

One variant of Poker that has proven to be increasingly popular is video poker. In video Poker, a player places his or her bet, then the player is typically dealt five cards, all face up. The player can then select which cards are to be held, or, alternatively, which cards are to be discarded. The discarded cards are replaced with new, face up cards. If the player's resulting hand matches one of a set of winning hands, the player is paid based on a pay table associated with the game.

Although video Poker is gaining in popularity, some players find the lack of interaction with other players or other randomness to make video Poker less exciting than other games. What is therefore needed is a means of introducing an additional, random component to video poker.

### SUMMARY OF THE INVENTION

Accordingly, the present invention is directed to a card game enhancement that substantially obviates one or more of the problems due to limitations and disadvantages of the related art.

An object of the present invention is to provide a means by which games, and especially card games, can be made more exciting to players.

A further object of the present invention is to introduce a random factor into games, including, but not limited to, video Poker, Blackjack, and the like.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention introduces a new means by which card games can be made more attractive to players while also creating an incentive for the players to play competitively. Although the discussion in this specification deals primarily with card games, and specifically video Poker, it should be apparent to one skilled in the art that the present invention can be applied to a variety of other games including other games of chance.

The present invention makes a card game more attractive by randomly selecting, from a set of winning hands, a bonus pay or alternative winning hand. In a preferred video Poker embodiment, the invention implements a spinning “wheel” to which is affixed at least one card representing a possible winning hand. While a spinning wheel is presently preferred, it should be apparent to one skilled in the art that alternative random or pseudo-random selection techniques can be substituted therefor without departing from the spirit or the scope of the present invention. When wheel is spun, the card selected by the wheel indicates a bonus pay hand for that game. In this embodiment, a pay table entry or entries associated with a selected bonus pay hand are modified to increase the payout for that hand. In one contemplated embodiment, a second wheel may be spun to determine a fixed amount or a multiplicative factor by which the pay table entry or entries are modified.

Although pay tables are typically associated with games having multiple potential winning combinations, such as video Poker, slot machines, and the like, as used herein the term pay table also includes an established ranking of potential outcomes to determine a winning outcome. By way of example, without intending to limit the present invention, the hand rankings listed in Table 1 can be considered a pay table, and the ranking may be modified such that an otherwise low-ranking hand, such as a straight, may rank higher than a Royal Flush.

In an alternative embodiment, the wheel is spun and the card selected by the wheel can indicate an alternate winning hand for that game. In this embodiment, a player holding an alternate winning hand may lose the game against another player or the house but still win money from a secondary pot. Such a secondary pot is preferably a fixed sum contributed by the house, although a secondary pot of progressive value, such as one in which the value of the pot gradually increases as a percentage of the house's rake until the secondary pot is won, is also envisioned.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flowchart providing a high-level overview of a preferred embodiment of the present invention.

FIG. 2 is a flowchart providing a high level overview of an alternative embodiment of the present invention.

FIG. 3 is a screen capture of a preferred video Poker embodiment of the present invention.

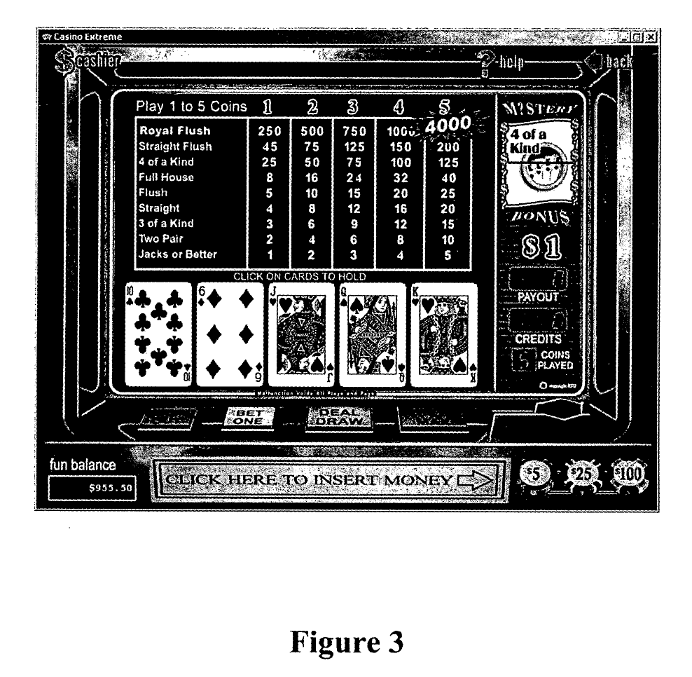

### DETAILED DESCRIPTION OF THE PREFERRED EMBODIMENT

Reference will now be made in detail to the preferred embodiments of the present invention, examples of which are illustrated in the accompanying drawings.

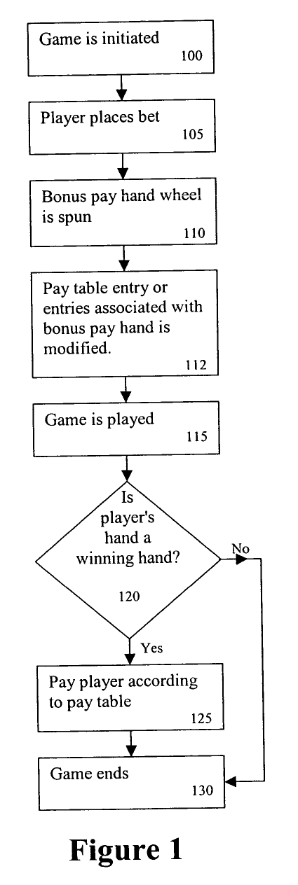

The present invention provides an enhancement to traditional games that serves as an incentive for players to continue playing the game. FIG. 1 is a flowchart providing a high-level overview of the present invention.

As FIG. 1 illustrates, the present invention begins with initiation of game play, illustrated by Block 100. In a preferred video Poker embodiment, such initiation takes the form of the video Poker game “shuffling” at least one deck of cards, and player placing a bet, illustrated by Block 105.

When game play had been initiated, but preferably before any cards are dealt or the game otherwise begins in earnest, a wheel or other random or pseudo-random selection mechanism is used to select a bonus pay hand from a set of possible winning hands, illustrated by Block 110. In a preferred video Poker embodiment, a wheel with cards representing the possible hands, including, but not limited to, Royal Flush, straight flush, 4 of a kind, full house, flush, straight, three of a kind, two pair, high pair, and none, is spun to select a bonus pay hand. Although a presently preferred embodiment uses one card for each possible hand, it should be apparent to one skilled in the art that alternative card ratios and arrangements can be implemented without departing from the spirit or the scope of the present invention, including selecting multiple alternative winning hands or a bonus for any winning hand.

In a preferred embodiment, pay table entry or entries associated with a bonus pay hand are modified. In this embodiment, the pay table entry or entries associated with a bonus pay hand are increased with respect to its traditional value, as illustrated in Block 112. In an alternative embodiment, pay table entries associated with all winning hands which are not the bonus pay hand may be decreased with respect to their traditional value. In still an another alternative embodiment, pay table entries with rankings equal to or above those of the bonus pay hand are increased. It should be apparent to one skilled in the art that alternative pay table modifications could also be used without departing from the spirit or the scope of the present invention.

In a preferred embodiment, game play proceeds as normal once an alternate winning hand has been selected, as illustrated by Block 115. As represented by Block 125, if the player's hand is a winning hand (Block 120), the player is paid according to the pay table, including any variations thereto introduced in Block 112. If the player's hand is not a winning hand, or once the player has been paid, game play ends (Block 130).

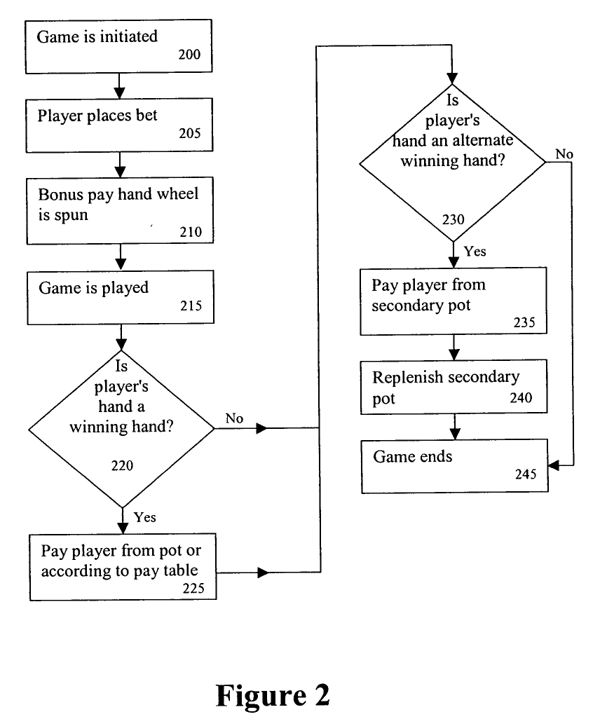

It should be apparent to one skilled in the art that the present invention is not limited to Poker and Poker-like games. Instead, the present invention can be used in a variety of gaming scenarios. By way of example, without intending to limit the present invention, the present invention can be utilized in a Blackjack, or “21”, embodiment. In such an embodiment, a wheel with possible hand values, including traditionally non-winning values, may be spun to determine an alternative winning hand. For example, the wheel may include values between sixteen and twenty-four, inclusive. Such an implementation may allow a player to be more aggressive in his or her gaming, thus potentially resulting in increased winnings. FIG. 2 is a flowchart providing a high-level overview of such an alternative embodiment of present invention.

As FIG. 2 illustrates, this example alternative embodiment begins with initiation of game play, illustrated by Block 200. In a video Blackjack embodiment, such initiation takes the form of the video Blackjack game “shuffling” at least one decks of cards, and player placing a bet, illustrated by Block 205.

When game play had been initiated, but preferably before any cards are dealt or the game otherwise begins in earnest, a wheel or other random or pseudo-random selection mechanism is used to select an alternate winning, illustrated by Block 210. In this sample video Blackjack embodiment, a wheel with cards representing hand values between sixteen and twenty-four is spun to select an alternative winning hand. Although a presently preferred embodiment uses one card for each possible hand, it should be apparent to one skilled in the art that alternative card ratios and arrangements can be implemented without departing from the spirit or the scope of the present invention, including selecting multiple alternative winning hands.

In a preferred embodiment, game play proceeds as normal once an alternate winning hand has been selected, as illustrated by Block 215. If the player's hand is a traditional winning hand (Block 220), the player is paid according to a pay table or based on the pot, whichever is appropriate for the game, as illustrated by Block 225. In a preferred embodiment, regardless of whether a player wins or loses the game as determined in Block 220, the player's hand is evaluated against the alternative winning hand, as illustrated in Block 230. In a preferred embodiment, a player whose hand matches the alternative winning hand is paid from the secondary pot (Block 235), and the secondary pot is replenished by the house (Block 240). In an alternative embodiment, the secondary pot may be a progressive jackpot to which the house contributes a portion of its rake or other winnings at the end of each game. In such an alternative embodiment, when a user wins the secondary pot, the secondary pot is replenished to a minimum level by the house. If the player does not hold an alternative winning hand, or once all winnings have been paid and the secondary pot is replenished, the game ends, as illustrated in Block 245.

While Poker is among the most popular card games in America, the number of Poker variations attests to the fact that many players prefer not to play using the same game rules repetitively. In fact, many players prefer to alternate between different variations with each game. One reason for such alternations is that different players prefer different variations because they feel that they have a competitive advantage in that variation. As a concession to the other players at the table who may not care for a certain Poker variation, some players will choose to split, or divide up, the “pot”, or winnings, with at least one other player. Frequently, the at least one other player is chosen based on that player having the lowest ranked hand or the lowest single card.

While splitting the pot is one way to encourage others to play Poker, most pot splitting techniques reward the best and worst players, which creates an odd incentive. For example, in a game with two poor Poker players and one good player, the two players may be motivated to always get the worst possible hand, based on their belief that they cannot beat the good player. An additionally contemplated embodiment of the present invention uses a wheel or other random or pseudo-random selection technique to select the card, hand, or other attribute that will win a portion of the pot. The portion won may be selected through a second wheel or other random or pseudo-random selection technique.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A game payout value modification method, comprising:
selecting a game to be played;
establishing a set of game outcomes;
establishing a pay table for the set of game outcomes;
initiating the game;
selecting at least one bonus winning outcome from the set of game outcomes;
modifying the pay table entry associated with the at least one selected bonus winning outcome;
playing the game until an outcome is determined for at least one player; and,
paying the at least one player according to the modified pay table.

2. The game payout modification method of claim 1, wherein the bonus winning outcome is selected at random from a set of outcomes with each possible outcome having substantially the same odds of being selected.

3. The game payout modification method of claim 1, wherein the bonus winning outcome is selected at random from a set of outcomes with different outcomes having different odds of being selected.

4. The game payout value modification method of claim 1, wherein the game to be played is a form of Poker.

5. The game payout value modification method of claim 1, wherein the game is Blackjack.

6. The game payout value modification method of claim 1, wherein the pay table modification is the enhancement of the payout associated with the bonus winning outcome.

7. The game payout value modification method of claim 6, wherein the enhanced payout is paid if a player wins the game with the bonus winning outcome.

8. The game payout value modification method of claim 1, wherein the pay table modification is the winning of an alternative pot.

9. The game payout value modification method of claim 8, wherein the alternative pot is won by a player if a game outcome associated with the player at the end of the game matches the bonus winning outcome, regardless of whether the player wins the game.

10. The game payout value modification method of claim 8, wherein the alternative pot is divided evenly among all players for whom an associated game outcome at the end of the game matches the bonus winning outcome, regardless of whether the player wins the game.

11. A game payout value modification method comprising:
establishing a pay table of payouts for possible game outcomes;
initiating game play;
allowing at least one player to place a bet;
selecting a bonus pay outcome from a set of possible outcomes;
modifying the pay table entry associated with the bonus pay outcome;
playing the game, such that at least one outcome is associated with each player;
awarding a player the payout from the pay table associated with the player outcome if the player outcome is a winning outcome; and
ending game play.

12. The game payout modification method of claim 11, wherein the pay table entry modification is the enhancement of the payout associated with the bonus pay outcome.

13. The game payout modification method of claim 12, wherein the level of enhancement is determined at random.

14. A game payout modification method comprising:
establishing a pay table of payouts for possible game outcomes;
initiating game play;
allowing at least one player to place a bet;
selecting an alternative winning outcome from a set of possible outcomes;
modifying the pay table entry associated with the alternative winning outcome;
playing the game, such that at least one outcome is associated with each player;
awarding a player the payout from the pay table associated with the player outcome regardless of whether the player outcome is a winning outcome if the player outcome matches the alternative winning outcome; and
ending game play.

15. The game payout modification method of claim 14, wherein the pay table entry modification is the payment of the value of an alternative pot.

16. The game payout modification method of claim 15, wherein the alternative pot is a progressive pot.

17. The game payout modification method of claim 14, wherein the pay table entry modification is the enhancement of the value associated with the alternative winning outcome.

18. A method of modifying the payout for a Poker game, comprising:
establishing a pay table of payouts for possible winning hands;
initiating game play;
allowing at least one player to place a bet;
selecting a bonus hand from a set of possible winning hands;
modifying the pay table entry associated with the bonus hand;
playing the Poker game, including dealing at least one hand to each player;
awarding a player the payout from the pay table associated with a player hand if the player hand is the winning hand; and
ending game play.

19. The Poker Game payout modification method of claim 18, wherein the pay table modification is the re-ordering of the pay table such that the selected bonus hand is the highest ranking hand.

20. The Poker Game payout modification method of claim 18, wherein the pay table modification is the assigning of a bonus winning value.
